(19) United States
(12) Patent Application Publication
(10) Pub. No.: US 2025/0002686 A1
(43) Pub. Date: Jan. 2, 2025

(54) Material For Molding

(71) Applicant: SEIKO EPSON CORPORATION, Tokyo (JP)

(72) Inventors: Tomohiro FUJITA, Matsumoto (JP); Masaaki AOTA, Suwa (JP); Takashi HIRAIWA, Fujimi (JP)

(21) Appl. No.: 18/757,770

(22) Filed: Jun. 28, 2024

(30) Foreign Application Priority Data
Jun. 30, 2023 (JP) 2023-107973

(51) Int. Cl. C08K 7/02

(52) U.S. Cl. CPC C08K 7/02; C08K 2201/003; C08K 2201/004

(57) ABSTRACT

A material for molding according to an embodiment of the present disclosure is a material for molding containing cellulose fibers and a resin. The resin contains a binder and urethane fibers. The resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate. An area value at the maximum 2 is smaller than an area value at the maximum 1.

The present application is based on, and claims priority from JP Application Serial Number 2023-107973, filed Jun. 30, 2023, the disclosure of which is hereby incorporated by reference herein in its entirety.

### BACKGROUND

### 1. Technical Field

The present disclosure relates to a material for molding.

### 2. Related Art

Molded bodies produced using a material containing cellulose fibers and a resin have been known. For example, Japanese Patent No. 7097521 proposes a cellulose fiber-reinforced thermoplastic resin molded body containing a thermoplastic resin, cellulose fibers, and organic fibers different from the cellulose fibers for the purpose of providing a molded body achieving both a sufficiently high bending elastic modulus (rigidity) and excellent impact strength.

However, in the materials of the related art, for example, when molding thermal history is involved, such as when molded bodies and gate materials during molding are melted, pelletized, and molded again, fibers may fall, and the occurrence of dust particles may occur.

### SUMMARY

The present disclosure is a material for molding containing cellulose fibers and a resin, wherein the resin contains a binder and urethane fibers, the resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate, and an area value at the maximum 2 is smaller than an area value at the maximum 1.

### BRIEF DESCRIPTION OF THE DRAWINGS

FIG. 1 is a diagram (Table 1) showing compositions of raw materials, methods of molding, and evaluation results of molded bodies about materials for molding of examples and comparative examples.

FIG. 2 is a diagram (Table 2) showing compositions of raw materials, methods of molding, and evaluation results of molded bodies about materials for molding of examples and comparative examples.

FIG. 3 is a diagram (Table 3) showing compositions of raw materials, methods of molding, and evaluation results of molded bodies about materials for molding of examples and comparative examples.

### DESCRIPTION OF EMBODIMENTS

The following describes an embodiment of the present disclosure. The embodiment described below describes an example of the present disclosure. The present disclosure is not limited to the following embodiment at all and also include various modifications performed to the extent that the gist of the present disclosure is not changed. Note that all components described in the following are not necessarily essential components of the present disclosure.

### 1. MATERIAL FOR MOLDING

A material for molding according to an embodiment of the present disclosure is a material for molding containing cellulose fibers and a resin. The resin contains a binder and urethane fibers. The resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate. An area value at the maximum 2 is smaller than an area value at the maximum 1.

In cellulose fiber-reinforced thermoplastic resin molded bodies containing a thermoplastic resin, cellulose fibers, and organic fibers different from the cellulose fibers, falling of fibers from molded bodies is conspicuous, and they are unfortunately not suitable for molded bodies used in environments in which the occurrence of dust particles or the like becomes a problem, such as members having fluid channels and members disposed around the members, ink cartridges, various containers, and various fixtures, for example.

It has now been found that a material for molding containing cellulose fibers, a binder, and urethane fibers can be suitably used for production of a molded body containing cellulose fibers, being excellent in both impact strength and bending strength, and having reduced occurrence of dust particles.

It is thought that such effects can be obtained because of the following reasons. That is, by containing cellulose and the binder, which have high theoretical strength and excellent shape retention properties and containing urethane, which has excellent compatibility and affinity with the cellulose fibers and the binder, the functions of these components are prevented and inhibited from being canceled, and the functions of these components can be sufficiently exhibited. More specifically, during production of the molded body using the material for molding and/or in the molded body produced using the material for molding, the wettability of the binder to the cellulose fibers can be increased while sufficiently exhibiting the functions of the cellulose fibers and the binder, and interfacial separation among the different components constituting the molded body can be suitably prevented and inhibited. Consequently, it is thought that the above effects can be obtained. The interfacial separation among the different components constituting the molded body can be suitably prevented and inhibited, and thus the molded body with problems such as the occurrence of dust particles effectively prevented can be obtained.

Containing the cellulose fibers, which are natural materials derived from plants and abundant, can suitably address environmental problems, saving of buried resources, and the like and is advantageous also from the viewpoint of stable supply of the material for molding and the molded body produced using the same, cost reduction, and the like. In addition, the cellulose fibers are components contained in large numbers, for example, wastepaper, waste cloth, and the like apart from virgin pulp and are advantageous also from the viewpoint of promoting effective reuse of resources.

Urethane fibers are contained in large numbers in waste clothes or the like, but in the case of, for example, being mixed with other components in blends or the like, it is difficult to isolate the urethane fibers from the other components. In addition, because urethane fibers generate toxic gases during heat processing at 200° C. or higher, it has been difficult to reuse them and difficult to incinerate them; however, according to the present disclosure, urethane fibers contained in waste clothes or the like can be suitably reused.

In contrast, if the above condition is not satisfied, no satisfactory results are obtained. For example, even if the cellulose fibers and the binder are contained, if urethane is not contained, the wettability of the binder to the cellulose fibers cannot be made sufficiently good, and in the molded body produced using the material for molding, interfacial separation between different components is likely to occur, and the strength of the molded body cannot be made sufficiently good. In addition, the molded body produced using the material for molding is likely to cause a problem of the occurrence of dust particles.

Even if the cellulose fibers and the urethane fibers are contained, if the binder is not contained, the moldability of the molded body conspicuously reduces, making it difficult to produce the molded body itself.

Even if the binder and the urethane fibers are contained, if the cellulose fibers are not contained, the effect by containing the cellulose fibers described above is not produced, and the strength of the molded body produced using the material for molding is conspicuously low.

Meanwhile, when molding thermal history is involved, such as when molded bodies and gate materials during molding are melted, pelletized, and molded again, the resin in the material for molding deteriorates in various characteristics caused by thermal decomposition. In particular, low-temperature melting resins, which melt at less than 200° C., are likely to be thermally decomposed. In addition, when molding thermal history is involved, falling of the fibers from the molded body is made more conspicuous, making it difficult to reduce the occurrence of dust particles.

Given these circumstances, the inventors of the present disclosure have earnestly studied to find out that the occurrence of dust particles can be well reduced even when molding thermal history is involved by a resin containing a binder and urethane fibers moderately having a high-molecular weight component.

The following describes various raw materials contained in the material for molding.

### 1.1 Cellulose Fibers

The material for molding according to the present embodiment contains the cellulose fibers.

The cellulose fibers are a component that significantly contributes to retention of the shape of the molded body produced using the material for molding according to the present embodiment and exerts a significant effect on the characteristics of the molded body, such as strength.

Cellulose is a natural material derived from plants and abundant. Because of this, using cellulose fibers can suitably address environmental problems, saving of buried resources, and the like and is preferred also from the viewpoint of stable supply of the material for molding and the molded body produced using the same, cost reduction, and the like. In addition, the cellulose fibers, among various fibers, have particularly high theoretical strength and are advantageous also from the viewpoint of improving the strength of the molded body.

Examples of the cellulose fibers include cotton, hemp, rayon, and cupra. As the cellulose fibers, virgin pulp may be used or wastepaper, waste cloth, or the like may be reused.

The cellulose fibers normally mainly contain cellulose and may contain components other than cellulose. Examples of such components include hemicellulose and lignin.

As the cellulose fibers, ones subjected to processing such as bleaching may be used.

The average length of the cellulose fibers, which is not particularly limited, is preferably less than 3 mm, more preferably 50 μm or more less than 500 μm, and even more preferably 100 μm or more and less than 400 μm.

With this, there is a tendency that the shape stability, the strength, and the like of the molded body produced using the material for molding can be made better. In addition, there is a tendency that the occurrence of dust particles in the molded body produced using the material for molding can be prevented and reduced more effectively. In particular, there is a tendency that the occurrence of dust particles can be better reduced even when molding thermal history is involved. In addition, unwilling irregularities may be able to be prevented from occurring on the surface of the molded body produced using the material for molding more effectively. Note that the fiber length is determined by the method conforming to ISO 16065-2: 2007.

The average diameter of the cellulose fibers, which is not particularly limited, is preferably less than 100 μm, more preferably 3 μm or more and less than 50 μm, and even more preferably 5 μm or more and less than 20 μm.

With this, there is a tendency that the shape stability, the strength, and the like of the molded body produced using the material for molding can be made better. In addition, there is a tendency that the occurrence of dust particles can be better reduced even when molding thermal history is involved. In addition, there is a tendency that unwilling irregularities can be prevented from occurring on the surface of the molded body produced using the material for molding more effectively.

The average aspect ratio of the cellulose fibers, that is, the ratio of the average length to the average diameter, which is not particularly limited, is preferably 10 or more and 1,000 or less and more preferably 15 or more and 100 or less.

With this, there is a tendency that the shape stability, the strength, and the like of the molded body produced using the material for molding can be made better. In addition, there is a tendency that the occurrence of dust particles in the molded body produced using the material for molding can be prevented and reduced more effectively. In particular, there is a tendency that the occurrence of dust particles can be better reduced even when molding thermal history is involved. In addition, unwilling irregularities may be able to be prevented from occurring on the surface of the molded body produced using the material for molding more effectively.

The content of the cellulose fibers is preferably 2% by mass or more and 40% by mass or less, more preferably 2% by mass or more and 35% by mass or less, even more preferably 2% by mass or more and 30% by mass or less, particularly preferably 2% by mass or more and 25% by mass or less, and even particularly preferably 2% by mass or more and 20% by mass less with respect to the total mass of the material for molding. When the content of the cellulose fibers is within the above range, there is a tendency that the shape stability, the strength, and the like of the molded body produced using the material for molding can be made better. In addition, there is a tendency that the occurrence of dust particles can be better reduced even when molding thermal history is involved.

### 1.2 Resin

The material for molding according to the present embodiment contains the resin, and the resin contains the binder and the urethane fibers.

The content of the resin is preferably 50% by mass or more and 99% by mass or less, more preferably 60% by mass or more and 95% by mass or less, and even more preferably 70% by mass or more and 95% by mass or less with respect to the total mass of the material for molding. With this, there is a tendency that the occurrence of dust particles can be better reduced even when molding thermal history is involved.

### 1.2.1 Binder

By the resin in the material for molding according to the present embodiment containing the binder, the toughness of the molded body produced using the material for molding according to the present embodiment can be increased, and the impact resistance of the molded body can be made sufficiently good.

The binder may be any one so long as it can exhibit the above function and is normally a resin material.

Examples of the resin material as the binder, that is, a binder resin include polyolefins such as polyethylene and polypropylene and polyesters such as aliphatic polyesters and aromatic polyesters. One or two or more in combination selected from these are preferably used, in which the binder resin is preferably at least one of polyolefins and aliphatic polyesters.

With this, there is a tendency that the affinity between the binder and urethane can be made better and the occurrence of dust particles can be better reduced even when molding thermal history is involved.

An aliphatic polyester is a polyester having no aromatic chemical structure and a polyester in which all constituting monomers do not have any aromatic chemical structure. Examples of the aliphatic polyester include ones in which both a polycarboxylic acid component and a polyhydric alcohol component as the constituting monomers have an aliphatic alkylene group. The aliphatic polyester may be one containing monomers having a hydroxy group and a carboxy group in the molecule. Examples of the aliphatic polyester containing monomers having a hydroxy group and a carboxy group in the molecule include polylactic acid.

When the aliphatic polyester is one having a chemical structure in which the polycarboxylic acid component having an aliphatic alkylene group and the polyhydric alcohol component having an aliphatic alkylene group are polymerized, the aliphatic polyester is preferably one having a chemical structure in which an alkylene dicarboxylic acid having an alkylene group with a carbon chain length of two or more and six or less and an alkylene diol having an alkylene group with a carbon chain length of two or more and eight or less are condensed. With this, there is a tendency that the function as the binder can be exhibited more effectively, the compatibility with urethane can be made better, and the impact strength and the bending strength of the molded body produced using the material for molding can be made better. In addition, there is a tendency that the occurrence of dust particles can be better reduced even when molding thermal history is involved.

The carbon chain length of the alkylene group of the alkylene dicarboxylic acid, which is preferably two or more and six or less, is more preferably two or more and five or less and even more preferably two or more and four or less. With this, there is a tendency that the impact strength and the bending strength of the molded body produced using the material for molding can be made better. In addition, there is a tendency that the occurrence of dust particles can be better reduced even when molding thermal history is involved.

The alkylene group of the alkylene dicarboxylic acid, which may be one having a branched structure, is preferably a linear one. With this, there is a tendency that the impact strength and the bending strength of the molded body produced using the material for molding can be made better. In addition, there is a tendency that the occurrence of dust particles can be better reduced even when molding thermal history is involved.

Examples of the alkylene dicarboxylic acid include succinic acid, glutaric acid, adipic acid, pimelic acid, suberic acid, azelaic acid, and sebacic acid. One or two or more in combination selected from these are preferably used.

The carbon chain length of the alkylene group of the alkylene diol, which is preferably two or more and eight or less, is more preferably two or more and six or less and even more preferably three or more and five or less. With this, there is a tendency that the impact strength and the bending strength of the molded body produced using the material for molding can be made better. In addition, there is a tendency that the occurrence of dust particles can be better reduced even when molding thermal history is involved.

The alkylene group of the alkylene diol, which may be one having a branched structure, is preferably a linear one. With this, there is a tendency that the impact strength and the bending strength of the molded body produced using the material for molding can be made better. In addition, there is a tendency that the occurrence of dust particles can be better reduced even when molding thermal history is involved.

Examples of the alkylene diol include 1,2-ethanediol, 1,3-propanediol, 1,4-butanediol, 1,5-pentanediol, 1,6-hexanediol, 1,7-heptanediol, and 1,8-octanediol. One or two or more in combination selected from these are preferably used.

Specific examples of the aliphatic polyester containing the alkylene dicarboxylic acid and the alkylene diol satisfying the above conditions as monomer components include polybutylene succinate, polybutylene succinate adipate, and polyethylene adipate. One or two or more in combination selected from these are preferably used. Among them, more preferred are polybutylene succinate, polybutylene succinate adipate, and polyethylene adipate.

These are materials having biodegradability and can suitably reduce environmental load by molded bodies. In addition, these materials are relatively low-priced and provide easy, stable availability. Thus, they are advantageous also from the viewpoint of stable supply of the material for molding and the molded body, cost reduction, and the like.

The content of the binder is preferably 35% by mass or more and 94% by mass or less, more preferably 40% by mass or more and 92% by mass or less, and even more preferably 50% by mass or more and 90% by mass or less with respect to the total mass of the material for molding. With this, there is a tendency that the impact strength and the bending strength of the molded body produced using the material for molding can be made better. In addition, there is a tendency that the occurrence of dust particles can be better reduced even when molding thermal history is involved.

When the content of the cellulose fibers and the content of the binder in the material for molding according to the present embodiment are XC [% by mass] and XB [% by mass], respectively, a relation of 0.01≤XC/XB≤0.60 is preferably satisfied, a relation of 0.02≤XC/XB≤0.50 is more preferably satisfied, and a relation of 0.03≤XC/XB≤0.45 is even more preferably satisfied. With this, there is a tendency that the impact strength and the bending strength of the molded body produced using the material for molding can be made better. In addition, there is a tendency that the occurrence of dust particles can be better reduced even when molding thermal history is involved.

### 1.2.2 Urethane Fibers

The resin in the material for molding according to the present embodiment contains the urethane fibers. The urethane fibers are a kind of resin fibers and are fibers containing a material containing urethane. The form of the urethane fibers in the material for molding according to the present embodiment may be a fibrous form or an indeterminate form in which part or all of the fibers are melted and then solidified. Thus, the urethane fibers in the material for molding may be a fibrous form, an indeterminate form, or a mixture of these. The same also applies to other resin fibers other than the urethane fibers.

The urethane fibers normally melt in the process of production of the molded body using the material for molding according to the present embodiment, especially in heating processing during molding.

Urethane is a component having excellent affinity with both the cellulose fibers and the binder described above.

Such urethane functions as a compatibilizer when producing the molded body using the material for molding according to the present embodiment to improve compatibility with the cellulose fibers and the binder. With this, the wettability of the binder to the cellulose fibers increases, and the bending strength of the molded body produced using the material for molding according to the present embodiment can be improved. In addition, by containing the binder, the heat resistance of the molded body produced using the material for molding according to the present embodiment can also be improved.

Urethane constituting the urethane fibers is only required to be a compound in which an amino group and an alcohol group react with each other via a carbonyl group to form new covalent bonding between the nitrogen of the amine and the carbon of the carbonyl group and is preferably polyurethane.

When the urethane fibers are fibers containing a material containing polyurethane, the number average molecular weight of the polyurethane is preferably 20,000 or more and 300,000 or less, more preferably 30,000 or more and 200,000 or less, and even more preferably 40,000 or more and 150,000 or less.

With this, there is a tendency that the affinity and the compatibility of the polyurethane with the cellulose fibers and the binder can be made better, and the impact strength and the bending strength of the molded body produced using the material for molding can be made better. In addition, there is a tendency that the occurrence of dust particles can be better reduced even when molding thermal history is involved.

The urethane fibers are fibrous in the material for molding according to the present embodiment, in which part of them may be, for example, powdery or a melted state.

The average length of the urethane fibers, which is not particularly limited, is preferably less than 3 mm, more preferably 50 μm or more and less than 500 μm, and even more preferably 100 μm or more and less than 400 μm. With this, there is a tendency that the impact strength and the bending strength of the molded body produced using the material for molding can be made better. In addition, there is a tendency that the occurrence of dust particles can be better reduced even when molding thermal history is involved.

The average diameter of the urethane fibers, which is not particularly limited, is preferably less than 100 μm, more preferably 3 μm or more and less than 50 μm, and even more preferably 5 μm or more and less than 20 μm. With this, there is a tendency that the impact strength and the bending strength of the molded body produced using the material for molding can be made better. In addition, there is a tendency that the occurrence of dust particles can be better reduced even when molding thermal history is involved.

The average aspect ratio of the urethane fibers, that is, the ratio of the average length to the average diameter, which is not particularly limited, is preferably 10 or more and 1,000 or less and more preferably 15 or more and 100 or less. With this, there is a tendency that the impact strength and the bending strength of the molded body produced using the material for molding can be made better. In addition, there is a tendency that the occurrence of dust particles can be better reduced even when molding thermal history is involved.

The content of the urethane fibers is preferably 2% by mass or more and 40% by mass or less, more preferably 3% by mass or more and 35% by mass or less, even more preferably 3% by mass or more and 30% by mass or less, particularly preferably 3% by mass or more and 25% by mass or less, and even particularly preferably 3% by mass or more and 20% by mass less with respect to the total mass of the material for molding. With this, there is a tendency that the impact strength and the bending strength of the molded body produced using the material for molding can be made better. In addition, there is a tendency that the occurrence of dust particles can be better reduced even when molding thermal history is involved.

When the content of the binder and the content of the urethane fibers in the material for molding according to the present embodiment are XB [% by mass] and XU [% by mass], respectively, a relation of 0.01≤XU/XB≤0.60 is preferably satisfied, a relation of 0.02≤XU/XB≤0.50 is more preferably satisfied, and a relation of 0.03≤XU/XB≤0.45 is even more preferably satisfied. With this, there is a tendency that the impact strength and the bending strength of the molded body produced using the material for molding can be made better. In addition, there is a tendency that the occurrence of dust particles can be better reduced even when molding thermal history is involved.

When the content of the cellulose fibers and the content of the urethane fibers in the material for molding according to the present embodiment are XC [% by mass] and XU [% by mass], respectively, a relation of 0.2≤XU/XC≤5.0 is preferably satisfied, a relation of 0.3≤XU/XC≤3.0 is more preferably satisfied, and a relation of 0.4≤XU/XC≤2.5 is even more preferably satisfied. With this, there is a tendency that the impact strength and the bending strength of the molded body produced using the material for molding can be made better. In addition, there is a tendency that the occurrence of dust particles can be better reduced even when molding thermal history is involved.

### 1.2.3 Other Resin Fibers

The resin in the material for molding according to the present embodiment may further contain resin fibers other than the urethane fibers (other resin fibers). By containing the other resin fibers, they function as a filler having wettability close to that of the binder, which is advantageous in view of making the molded body have higher strength.

Examples of the other resin fibers include polyester fibers, acrylic fibers, nylon fibers, and acetate fibers.

The average length of the other resin fibers, which is not particularly limited, is preferably less than 3 mm, more preferably 50 μm or more and less than 500 μm, and even more preferably 100 μm or more and less than 400 μm. With this, there is a tendency that the impact strength and the bending strength of the molded body produced using the material for molding can be made better. In addition, there is a tendency that the occurrence of dust particles can be better reduced even when molding thermal history is involved.

The average diameter of the other resin fibers, which is not particularly limited, is preferably less than 100 μm, more preferably 3 μm or more and less than 50 μm, and even more preferably 5 μm or more and less than 20 μm. With this, there is a tendency that the impact strength and the bending strength of the molded body produced using the material for molding can be made better. In addition, there is a tendency that the occurrence of dust particles can be better reduced even when molding thermal history is involved.

The average aspect ratio of the other resin fibers, that is, the ratio of the average length to the average diameter, which is not particularly limited, is preferably 10 or more and 1,000 or less and more preferably 15 or more and 100 or less. With this, there is a tendency that the impact strength and the bending strength of the molded body produced using the material for molding can be made better. In addition, there is a tendency that the occurrence of dust particles can be better reduced even when molding thermal history is involved.

The content of the other resin fibers is preferably 1% by mass or more and 30% by mass or less, more preferably 2% by mass or more and 25% by mass or less, and even more preferably 3% by mass or more and 20% by mass or less with respect to the total mass of the material for molding. With this, there is a tendency that the impact strength and the bending strength of the molded body produced using the material for molding can be made better. In addition, there is a tendency that the occurrence of dust particles can be better reduced even when molding thermal history is involved.

When the content of the binder and the content of the other resin fibers in the material for molding according to the present embodiment are XB [% by mass] and XO [% by mass], respectively, a relation of 0.01≤XO/XB≤0.45 is preferably satisfied, a relation of 0.02≤XO/XB≤0.36 is more preferably satisfied, and a relation of 0.03≤XO/XB≤0.30 is even more preferably satisfied. With this, there is a tendency that the impact strength and the bending strength of the molded body produced using the material for molding can be made better. In addition, there is a tendency that the occurrence of dust particles can be better reduced even when molding thermal history is involved.

When the content of the cellulose fibers and the content of the other resin fibers in the material for molding according to the present embodiment are XC [% by mass] and XO [% by mass], respectively, a relation of 0.1≤XO/XC≤3.8 is preferably satisfied, a relation of 0.2≤XO/XC≤2.1 is more preferably satisfied, and a relation of 0.3≤XO/XC≤1.7 is even more preferably satisfied. With this, there is a tendency that the impact strength and the bending strength of the molded body produced using the material for molding can be made better. In addition, there is a tendency that the occurrence of dust particles can be better reduced even when molding thermal history is involved.

### 1.2.4 Molecular Weight Distribution

The resin described above contained in the material for molding according to the present embodiment has a maximum 1 at a weight average molecular weight of 50,000 to 150,000 and a maximum 2 at a weight average molecular weight of 75,000 to 300,000 in a molecular weight distribution curve by a GPC method with chloroform as an eluate, in which an area value at the maximum 2 is smaller than an area value at the maximum 1. Thus, by the resin moderately having a high-molecular weight component, the occurrence of dust particles can be better reduced even when the thermal decomposition of the resin occurs by molding thermal history.

The GPC method is gel permeation chromatography and can be measured by the following procedure, for example. Two separation columns (TSKgel SuperHZM-H manufactured by Tosoh Corporation) are connected in series to a GPC apparatus (ACQUITY APC manufactured by Waters), which is used as a measurement apparatus. A measurement sample (the material for molding) is dissolved in chloroform as an eluate and filtered with a filter with a pore size of 0.45 μm, and GPC analysis is performed on a dissolved component, thereby obtaining a molecular weight distribution curve for the resin. The column temperature is set to 40° C., and an IR detector is used as a detector. Polystyrene (manufactured by Agilent) is used as a standard sample.

By using chloroform as the eluate, a resin that can be dissolved in chloroform can be measured. Examples of the resin that can be dissolved in chloroform include polybutylene succinate, polylactic acid, and urethane.

The method of peak calculation can be as follows, for example. With a chromatogram regarded as a linear function, the position with a slope of zero when differentiating is defined as a peak top. With the chromatogram regarded as the linear function, the position with a slope of zero when differentiating again is defined as a peak boundary. A peak is vertically divided from the peak boundary position, which is calculated as an area value of each peak. When a peak is sufficiently separate, the area value may be processed as a single peak. When two overlapping peaks can be sufficiently discriminated from each other, they may be processed as a shoulder peak, and a straight line may be drawn at the base of a smaller peak to calculate the area value. Furthermore, each peak area may be calculated using peak separation software. However, the match rate should be 90% or more.

The resin contained in the material for molding according to the present embodiment has the maximum 1 at a weight average molecular weight of 50,000 to 150,000 in the molecular weight distribution curve by the GPC method with chloroform as the eluate, in which the weight average molecular weight is more preferably 50,000 to 130,000 and even more preferably 60,000 to 120,000. When the maximum 1 is within the above range, there is a tendency that the occurrence of dust particles can be better reduced even when molding thermal history is involved. The maximum 1 preferably has a weight average molecular weight less than the weight average molecular weight at the maximum 2.

The resin contained in the material for molding according to the present embodiment has the maximum 2 at a weight average molecular weight of 75,000 to 300,000 in the molecular weight distribution curve by the GPC method with chloroform as the eluate, in which the weight average molecular weight is more preferably 80,000 to 280,000 and even more preferably 85,000 to 250,000. When the maximum 2 is within the above range, there is a tendency that the occurrence of dust particles can be better reduced even when molding thermal history is involved.

(Weight average molecular weight at maximum 2)/(weight average molecular weight at maximum 1) is preferably greater than 1.0 and 3.0 or less, more preferably greater than 1.0 and 2.5 or less, and even more preferably greater than 1.0 and 2.1 or less. In this case, there is a tendency that the occurrence of dust particles can be better reduced even when molding thermal history is involved.

### 1.3 Cross-Linking Agent

The material for molding according to the present embodiment may further contain a cross-linking agent. By containing the cross-linking agent, the molecular weight distribution in the resin is easily adjusted, and thus there is a tendency that the occurrence of dust particles can be better reduced even when molding thermal history is involved.

The cross-linking agent is preferably one having a reactive group that can be cross-linked with polyester and urethane. More specifically, the cross-linking agent preferably has a reactive group selected from a carbodiimide, an amine, an epoxy, an isocyanate, a protected isocyanate, a carboxylic acid anhydride, and a carboxylic acid. The cross-linking agent having such a reactive group can suitably react with polyester and urethane and easily adjusts the molecular weight distribution in the resin, and thus there is a tendency that the occurrence of dust particles can be better reduced even when molding thermal history is involved.

For the cross-linking agent, commercially available products may be used. Examples thereof include Metablen P-1901 (manufactured by Mitsubishi Chemical Corporation), Denacol EX-321 (manufactured by Nagase ChemteX Corporation, trimethylol propane polyglycidyl ether), Denacol EX-211 (manufactured by Nagase ChemteX Corporation, neopentyl glycol diglycidyl ether), Duranate E402-B80B (manufactured by Asahi Kasei Corporation, isocyanate), Carbodilite Elastostab H01 (manufactured by Nisshinbo Chemical Inc.), and MG-670P (manufactured by Riken Vitamin Co., Ltd.).

The content of the cross-linking agent is preferably 1% by mass or more and more preferably 2% by mass or more with respect to the total mass of the material for molding. The content of the cross-linking agent is preferably 10% by mass or less, more preferably 8% by mass or less, and even more preferably 6% by mass or less with respect to the total mass of the material for molding. When the content of the cross-linking agent is within the above range, there is a tendency that the occurrence of dust particles can be better reduced even when molding thermal history is involved.

The content of the cross-linking agent is preferably 0.1 part by mass or more and 20 parts by mass or less, more preferably 0.5 part by mass or more and 15 parts by mass or less, particularly preferably 1.0 part by mass or more and 10 parts by mass or less, and even particularly preferably 2.0 parts by mass or more and 8.0 parts by mass or less when the total content of the resin is 100 parts by mass. When the content of the cross-linking agent is within the above range, there is a tendency that the occurrence of dust particles can be better reduced even when molding thermal history is involved.

### 1.4 Flame Retardant

The material for molding according to the present embodiment may contain a flame retardant. For the flame retardant, known substances can be used. Examples of the flame retardant include inorganic flame retardants such as antimony compounds, metal hydroxides, nitrogen compounds, and boron compounds and organic flame retardants such as bromide compounds and phosphorous compounds.

For the flame retardant, commercially available products may be used. Examples thereof include Rabitle FP-110 (manufactured by Mitsui Fine Chemicals, Inc., phosphazene-based flame retardant) and Exolit OP1230 (manufactured by Clariant AG, phosphate-based flame retardant).

The content of the flame retardant is preferably 5% by mass or more and 30% by mass or less, more preferably 8% by mass or more and 25% by mass or less, and even more preferably 10% by mass or more and 20% by mass or less with respect to the total mass of the material for molding. When the content of the flame retardant is within the above range, there is a tendency that the occurrence of dust particles can be better reduced even when molding thermal history is involved while improving the flame retardancy of the molded body.

The content of the flame retardant is preferably 1 part by mass or more and 20 parts by mass or less, more preferably 5 parts by mass or more and 20 parts by mass or less, and even more preferably 10 parts by mass or more and 20 parts by mass or less when the total content of the cellulose fibers, the binder, and the urethane fibers is 100 parts by mass. When the content of the flame retardant is within the above range, there is a tendency that the occurrence of dust particles can be better reduced even when molding thermal history is involved while improving the flame retardancy of the molded body.

### 1.5 Other Components

The material for molding according to the present embodiment may contain other components such as colorants, insect repellants, mold inhibitors, antioxidants, UV absorbers, aggregation inhibitors, and mold release agents.

However, the content of the other components in the material for molding according to the present embodiment is preferably 10% by mass or less, more preferably 5% by mass or less, and even more preferably 3% by mass or less.

### 2. METHOD FOR PRODUCING MATERIAL FOR MOLDING

The following describes a method for producing the material for molding according to the present embodiment.

The material for molding according to the present embodiment can be produced by, for example, mixing together the components described above. In this case, the components may be mixed together at the same time or different times.

The material for molding according to the present embodiment may be produced by, for example, kneading together the components described above. With this, a compatibilization effect by urethan is effectively produced. For the kneading of the components, for example, a single-screw kneader or a twin-screw kneader can be used.

The strand-like material for molding obtained by kneading may be made into pellet-like material for molding by performing pelletization using, for example, a pelletizer of a strand type, a watering hot cut type, or the like.

The following method may be used as the method for producing the material for molding. Specifically, a kneaded product of the components described above may be molded into a sheet shape, which may be then cut into a desired shape using, for example, a shredder to make the pellet-like material for molding. The method for molding the kneaded product into a sheet shape is not particularly limited; examples thereof include a method of first accumulating the kneaded product in the air to make a sheet-like accumulation, compressing the accumulation with a calender apparatus to exclude air and to increase density, then heating it in a noncontact manner using a furnace, and then hot-pressing it with a hot press. The shape and size of pellets obtained by cutting are not particularly limited; for example, they can be made into a substantially rectangular parallelopiped with a length of one side of 2 mm or more and 5 mm or less.

The cellulose fibers for use in the production of the material for molding according to the present embodiment may be ones subjected to defibration processing in advance. In particular, ones obtained by defibrating a cellulose fiber source containing cellulose fibers, such as wastepaper and waste cloth, may be used.

When the material for molding according to the present embodiment is one containing the other resin fibers, the other resin fibers for use in the production of the material for molding according to the present embodiment may be ones subjected to defibration processing in advance. In particular, ones obtained by defibrating an other-resin-fiber source containing other fibers, such as waste cloth, may be used.

The above fiber sources, that is, the cellulose fiber source, a urethane fiber source, and an other-fiber-source may be coarsely crushed before defibration.

Coarse crushing of the fiber sources can be performed by, for example, shredding them into small pieces using a shredder having coarse crushing teeth in the atmosphere or the like. The form of the small pieces is, for example, a substantially cubic shape, a substantially rectangular parallelepipedal shape, or the like a few millimeters square.

The small pieces of the fiber sources become unraveled fibers by defibration. Defibration here refers to unraveling a plurality of integrated fibers into individual fibers.

Defibration can be suitably performed on a dry condition. The dry condition here refers to being performed in the air such as the atmosphere, not being performed in liquid. For the purpose of electrification prevention or the like, for example, water or the like may be sprayed onto the fibers. The dry defibration can be suitably performed with, for example, an airflow.

The defibration of the fiber sources may be performed separately for each fiber source or performed with a plurality of kinds of fiber sources mixed together.

As the fiber sources, ones containing a plurality of kinds of fibers, or more specifically, two or more kinds out of cellulose fibers, urethane fibers, and other resin fibers may be used. Examples of the fiber sources containing two or more kinds of fibers include blends.

The defibration of the fiber sources may be performed with components other than fibers, such as binders, flame retardants, and other components, contained.

### 3. MOLDED BODY

The following describes the molded body produced using the material for molding according to the present embodiment.

The molded body can be produced using the material for molding described above.

The shape of the molded body, which is not particularly limited, may be any shape such as a sheet shape, a block shape, a spherical shape, or a three-dimensional shape.

The molded body can be suitably produced by, for example, molding the material for molding described above by various methods of molding such as injection molding and press molding while heating it.

The heating temperature for the material for molding during molding, which is not particularly limited, is preferably lower than 200° C., more preferably 120° C. or higher and 190° C. or lower, and even more preferably 150° C. or higher and 180° C. or lower.

After the molding described above, for example, postprocessing such as mechanical processing such as grinding and polishing, painting, and plating may be performed.

### 4. EXAMPLES

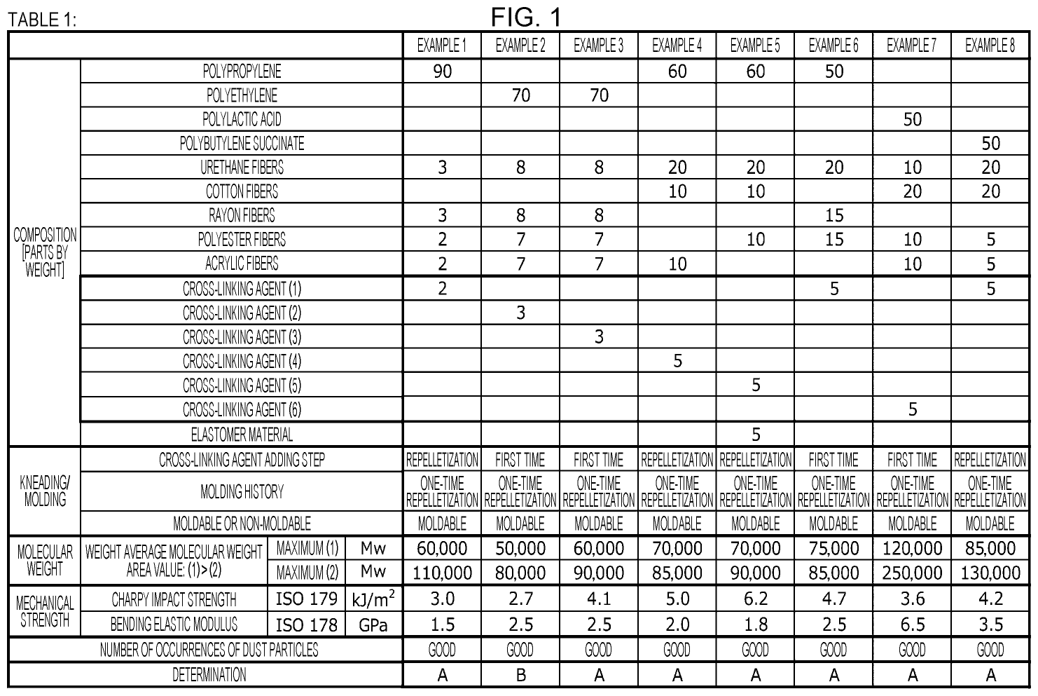

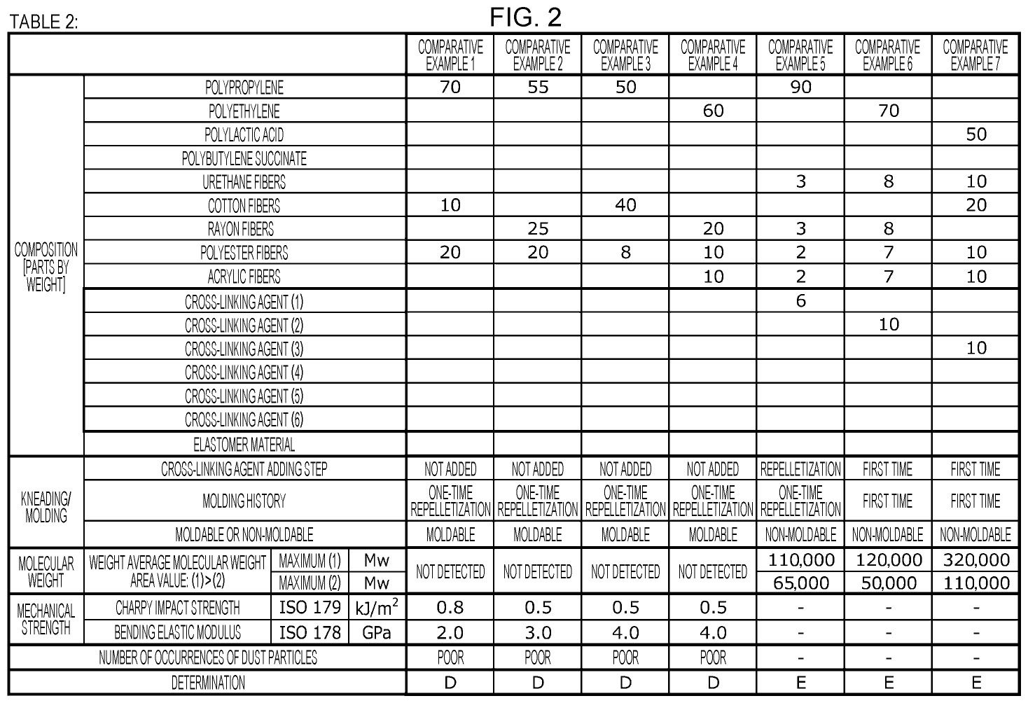

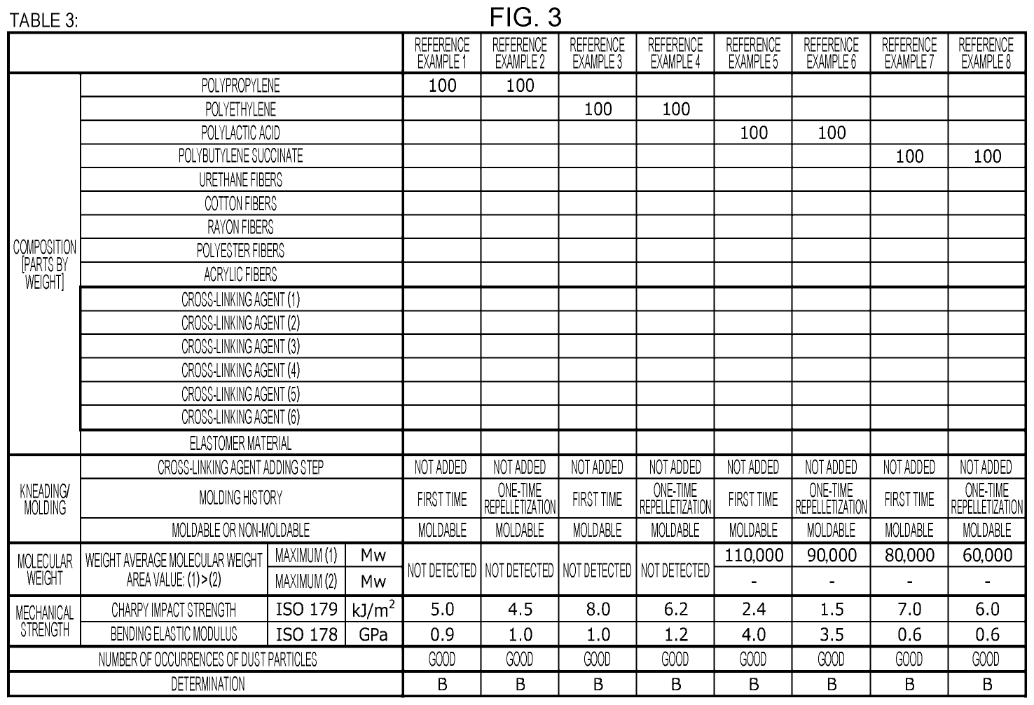

The following describes the present disclosure more specifically with reference to examples, but the present disclosure in not limited to these examples. In the columns of the compositions in FIGS. 1 to 3 (Tables 1 to 3), the unit of the values is parts by mass.

### 4.1 Preparation of Material for Molding

In accordance with the compositions in FIGS. 1 to 3 (Tables 1 to 3), materials for molding of examples and comparative examples were produced. Specifically, the various components were weighed and charged into a twin-screw kneader KZW15TW-45MG from Technovel Corporation to be kneaded together. The kneading conditions were a highest heating temperature of 180° C. and an extrusion ejection amount of 1 kg/hr. Next, after being processed into a strand shape, pellet-like materials for molding were made with a pelletizer.

As cellulose fibers (cotton fibers and rayon fibers), urethane fibers, polyester fibers, and acrylic fibers, clothes collected from markets were prepared as fiber sources, and the fiber sources were shredded into a substantially cubic shape a few millimeters square using a shredder having coarse crushing teeth in the air, and then an airflow was blown thereon to defibrate them, which were used.

The average length of the cellulose fibers contained in the materials for molding was 1.5 mm. The average diameter of the cellulose fibers was 15 μm. The average length of the urethane fibers was 1.5 mm. The average diameter of the urethane fibers was 50 μm. The number average molecular weight of polyurethane constituting the urethane fibers was 60,000.

For the material for molding obtained as above, its weight average molecular weight was measured by the GPC method. Specifically, two separation columns (TSKgel SuperHZM-H manufactured by Tosoh Corporation) were connected in series to a GPC apparatus (ACQUITY APC manufactured by Waters), which was used as a measurement apparatus. A measurement sample (the material for molding) was dissolved in chloroform as an eluate and filtered with a filter with a pore size of 0.45 μm, and GPC analysis was performed on a dissolved component, thereby obtaining a molecular weight distribution curve for the resin. The column temperature was set to 40° C., and an IR detector was used as a detector. Polystyrene (manufactured by Agilent) was used as a standard sample. The method of peak calculation was carried out as described above.

The descriptions in FIGS. 1 to 3 (Tables 1 to 3) are supplementarily described as follows:

### Binder

Polypropylene (manufactured by Prime Polymer Co., Ltd., H700)
Polyethylene (manufactured by Prime Polymer Co., Ltd., 2208J)
Polylactic acid (manufactured by Unitika Ltd., Terramac TE-2000)
Polybutylene succinate (manufactured by Mitsubishi Chemical Corporation, Bio PBS FZ71PB)

### Cross-Linking Agent

Cross-linking agent 1 (Metablen P-1901, manufactured by Mitsubishi Chemical Corporation)
Cross-linking agent 2 (Denacol EX-321, manufactured by Nagase ChemteX Corporation, trimethylol propane polyglycidyl ether)
Cross-linking agent 3 (Denacol EX-211, manufactured by Nagase ChemteX Corporation, neopentyl glycol diglycidyl ether)
Cross-linking agent 4 (Duranate E402-B80B, manufactured by Asahi Kasei Corporation, isocyanate)
Cross-linking agent 5 (Carbodilite Elastostab H01, manufactured by Nisshinbo Chemical Inc.)
Cross-linking agent 6 (MG-670P, manufactured by Riken Vitamin Co., Ltd.)

### Elastomer Material

Aronkasei Co., Ltd., ES-A60NX

### 4.2 Production of Molded Body

For each of the materials for molding of the examples and the comparative examples, injection molding was performed using an injection molding machine (manufactured by Nissei Plastic Industrial Co., Ltd., THX40-5V) to produce a molded body for evaluating Charpy impact strength and molded bodies for evaluating a bending elastic modulus and for evaluating the number of occurrences of dust particles described below. The heating temperature of the material for molding during injection molding was set to 180° C. The molded body for evaluating Charpy impact strength was made into a rectangular plate-like molded body with a long side of 80 mm±2 mm, a short side of 4.0 mm±0.2 mm, and a thickness of 10.0 mm±0.2 mm. The molded bodies for evaluating a bending elastic modulus and for evaluating the number of occurrences of dust particles were each made into a rectangular plate-like molded body with a long side of 80 mm±2 mm, a short side of 10.0 mm±0.2 mm, and a thickness of 4.0 mm±0.2 mm.

In the molding history in FIGS. 1 to 3 (Tables 1 to 3), “One-time repelletization” means that the molded body after being subjected to the above molding was repelletized, and molding was again performed in the same manner as above. “First time” means that only first-time, one-time molding is performed without performing repelletization. In the cross-linking agent adding step in FIGS. 1 to 3 (Tables 1 to 3), “Repelletization” means that addition is performed when the molded body subjected to the above molding is repelletized, and “First time” means that addition is performed only during the kneading of the raw materials. Thus, molded bodies for evaluation in the examples and the comparative examples were obtained.

### 4.3 Evaluation Tests

### 4.3.1 Charpy Impact Strength

For each of the molded bodies for evaluating Charpy impact strength obtained above, the Charpy impact strength was measured in conformity with ISO 179 (JIS K7111) using Impact Tester IT manufactured by Toyo Seiki Seisaku-sho, Ltd. In the measurement of the Charpy impact strength, the hammer weight was set to 4J (WR 2.14 N/m), the raising angle was 150°, the notch remaining width was 8.0 mm±0.2 mm, and the notch angle was 45°.

### 4.3.2 Bending Elastic Modulus

For each of the molded bodies for evaluating a bending elastic modulus obtained above, the bending elastic modulus was measured in conformity with ISO 178 (JIS K7171) using 68TM-30 manufactured by Instron. In the measurement of the bending elastic modulus, the distance between supports was set to 64 mm.

### 4.3.3 Number of Occurrences of Dust Particles

For the molded body for evaluating the number of occurrences of dust particles obtained above, the Charpy impact strength test was performed repeatedly 10 times, and a particle amount in the area with a radius of 10 cm in the vicinity of the impact point of the tester was measured. When the particle amount was compared with a value before performing the test, one with a total of the number of occurrences of dust particles of 20% or less relative to the initial value was evaluated to be “Good,” whereas one with a total of the number of occurrences of dust particles of greater than 20% relative to the initial value was evaluated to be “Poor.” Note that fragments of a millimeter order, which is beyond the measurement range of a particle counter, assume use environments of printer heads, sensors, or the like and were made out of consideration.

### 4.3.4 Complex Evaluation

For each of the examples and the comparative examples, from the measurement result of the Charpy impact strength, the measurement result of the bending elastic modulus, and the measurement result of the number of occurrences of dust particles, a complex evaluation was performed in accordance with the following criteria:

### Criteria

A: Determination in the occurrence of dust particles: Good, Charpy impact strength: 2.5 kJ/m² or more, and bending elastic modulus: 1.5 GPa or more
B: Determination in the occurrence of dust particles: Good, Charpy impact strength: 2.5 kJ/m² or more, or bending elastic modulus: 1.5 GPa or more (however, except for the range of Determination A above)
C: Determination in the occurrence of dust particles: Good, Charpy impact strength: less than 2.5 kJ/m², and bending elastic modulus: less than 1.5 GPa
D: Determination in the occurrence of dust particles: Poor
E: Non-moldable

### 4.4 Evaluation Results

FIGS. 1 to 3 (Tables 1 to 3) show the evaluation results.

It has been found from the results shown in FIGS. 1 to 3 (Tables 1 to 3) that the materials for molding according to the examples that are each a material for molding containing cellulose fibers and a resin, in which the resin contains a binder and urethane fibers, the resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate, and an area value at the maximum 2 is smaller than an area value at the maximum 1 can well reduce the occurrence of dust particles even when molding thermal history is involved.

In contrast, the materials for molding according to the comparative examples, which do not satisfy the above configuration, could not reduce the occurrence of dust particles when molding thermal history was involved. Note that the materials for molding according to the reference examples did not cause a problem of the occurrence of dust particles because they do not contain any fiber components.

The following is derived from the embodiment described above.

An aspect of the material for molding is a material for molding containing cellulose fibers and a resin, wherein the resin contains a binder and urethane fibers, the resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate, and an area value at the maximum 2 is smaller than an area value at the maximum 1.

In the aspect of the material for molding, the material for molding may further contain a cross-linking agent.

In any aspect of the material for molding, the cross-linking agent may have a reactive group selected from a carbodiimide, an amine, an epoxy, an isocyanate, a protected isocyanate, a carboxylic acid anhydride, and a carboxylic acid.

In any aspect of the material for molding, a content of the cellulose fibers may be 2% by mass or more and 40% by mass or less with respect a total mass of the material for molding.

In any aspect of the material for molding, the cellulose fibers may have an average length of less than 3 mm.

In any aspect of the material for molding, the cellulose fibers may have an average diameter of less than 100 μm.

In any aspect of the material for molding, a content of the binder may be 35% by mass or more and 94% by mass or less with respect a total mass of the material for molding.

In any aspect of the material for molding, a content of the urethane fibers may be 2% by mass or more and 40% by mass or less with respect a total mass of the material for molding.

The present disclosure is not limited to the embodiment described above, and various modifications can be made. For example, the present disclosure includes substantially the same configuration as the configuration described in the embodiment, that is, for example, configurations with the same function, method, and result or configurations with the same object and effect. The present disclosure includes configurations in which inessential parts of the configuration described in the embodiment are replaced. The present disclosure includes configurations that produce the same effect as that of the configuration described in the embodiment or configurations that can achieve the same object as that of the configuration described in the embodiment. The present disclosure includes configurations in which known technologies are added to the configuration described in the embodiment.

What is claimed is:

1. A material for molding comprising:
cellulose fibers; and
a resin, wherein
the resin contains a binder and urethane fibers,
the resin has a maximum 1 at a weight average molecular weight of 50,000 to 150,000 and a maximum 2 at a weight average molecular weight of 75,000 to 300,000 in a molecular weight distribution curve by a GPC method with chloroform as an eluate, and
an area value at the maximum 2 is smaller than an area value at the maximum 1.

2. The material for molding according to claim 1, further comprising a cross-linking agent.

3. The material for molding according to claim 2, wherein the cross-linking agent has a reactive group selected from a carbodiimide, an amine, an epoxy, an isocyanate, a protected isocyanate, a carboxylic acid anhydride, and a carboxylic acid.

4. The material for molding according to claim 1, wherein a content of the cellulose fibers is 2% by mass or more and 40% by mass or less with respect a total mass of the material for molding.

5. The material for molding according to claim 1, wherein the cellulose fibers have an average length of less than 3 mm.

6. The material for molding according to claim 1, wherein the cellulose fibers have an average diameter of less than 100 μm.

7. The material for molding according to claim 1, wherein a content of the binder is 35% by mass or more and 94% by mass or less with respect a total mass of the material for molding.

8. The material for molding according to claim 1, wherein a content of the urethane fibers is 2% by mass or more and 40% by mass or less with respect a total mass of the material for molding.
